(19) United States
(12) Patent Application Publication
(10) Pub. No.: US 2012/0215825 A1
(43) Pub. Date: Aug. 23, 2012

(54) EFFICIENT MULTIPLICATION TECHNIQUES

(76) Inventor: Abhay M. Mavalankar, Santa Clara, CA (US)

(21) Appl. No.: 13/031,697

(22) Filed: Feb. 22, 2011

(51) Int. Cl. G06F 7/38

(52) U.S. Cl. 708/551

(57) ABSTRACT

Techniques are disclosed that involve the multiplication of values. For instance, a plurality of partial products may be calculated from a first operand and a second operand. This calculating bypasses calculating partial products having corresponding shift values that are less than a shift threshold value. These partial products are summed to produce a summed product. In turn, the summed product is truncated into a final product having a final precision. This final precision may be a shared precision employed by multiple processing units (e.g., algorithmic units in a graphics or display processing pipeline).

### BACKGROUND

Devices may employ a set of processing (or algorithmic) units that exchange numerical data at a particular precision. For instance, a video or graphics processing pipeline is often characterized by a pipeline precision (such as 10 bits) that is shared among its different processing units.

Although processing units exchange data a particular shared precision, a processing unit may internally employ a higher precision. This higher precision may arise from various mathematical operations, such as multiplication. More particularly, such operations may produce (from input values) results having a higher precision than the input values.

However, before communicating its higher precision results to a next processing unit, the processing unit will round the results back to the shared (pipeline) precision. Despite this, processing units (e.g., units within graphics and display processing pipelines) employ conventional multiplication techniques. These conventional techniques do not exploit the fact that the precision of their results will be rounded down.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary apparatus;

FIG. 2 is a logic flow diagram; and

FIG. 3 is a diagram of an exemplary operational environment.

### DETAILED DESCRIPTION

Embodiments provide techniques involving the multiplication of values. For instance, a plurality of partial products may be calculated from a first operand and a second operand. This calculating bypasses calculating partial products having corresponding shift values that are less than a shift threshold value. These partial products are summed to produce a summed product. In turn, the summed product is truncated into a final product having a final precision. This final precision may be a shared precision employed by multiple processing units (e.g., algorithmic units in a graphics or display processing pipeline).

The employment of such techniques may advantageously provide significant efficiency improvements associated with multiplication operations (which are common in image processing and display (e.g., graphics) processing environments). For instance, such techniques may reduce circuitry (e.g., gate count) of the conventional multiplier. Also, such technique may increase the speed of such multiplications. Moreover, such techniques may be programmable. For instance, the shift threshold value (as well as other parameters) may be programmable settings. In embodiments, such settings may be selected to provide desired levels of efficiency and/or accuracy.

In many scenarios, especially those involving operands of higher bit widths for color space conversion algorithms, conventional combinational multipliers ignore the sparseness of the operands. This leads to a resulting synthesized design that can be excessively complex (e.g., a hardware design having a huge gate count). Also, as described above, scenarios exist where an entire multiplier product is not needed, but only a truncated portion of the product is used. Embodiments may leverage such redundancies to produce more efficient designs (e.g., designs having lower gate counts).

As described above, a processing unit may internally employ a bit precision that is higher than the shared (pipeline) precision. For example, a particular processing unit may provide a finite impulse response (FIR) filtering operation that receives 10 bit pixel values and employs (as filter taps) 12 bit coefficients. This filtering operation multiplies the pixel values and coefficients to produce 22 bit results. Also, the processing unit may optionally perform further mathematical operations that expand this precision further.

However, when passing the results of such operations to a next processing unit, the precision is typically reduced to the shared (or pipeline) bit precision. This reduction in precision typically involves truncating one or more least significant bits (LSBs) from a result value.

A multiplication of two operands may be decomposed into the calculation of several partial products (also referred to as mini products or sub-products). Each partial product calculation involves multiplying a portion (a set of contiguous digits) from the first operand with a portion (a set of contiguous digits) from the second operand. Based on the orders of magnitude of these portions, the multiplied result is shifted by a corresponding amount to yield the partial product. The partial products are then summed into a final product value.

Embodiments advantageously improve the efficiency of multiplication operations by exploiting the redundancy present when the final product is truncated. For instance, embodiments may bypass the multiplication of particular portion pairings. Such bypassed pairings may include pairings having a corresponding bit shift that is less than a particular threshold.

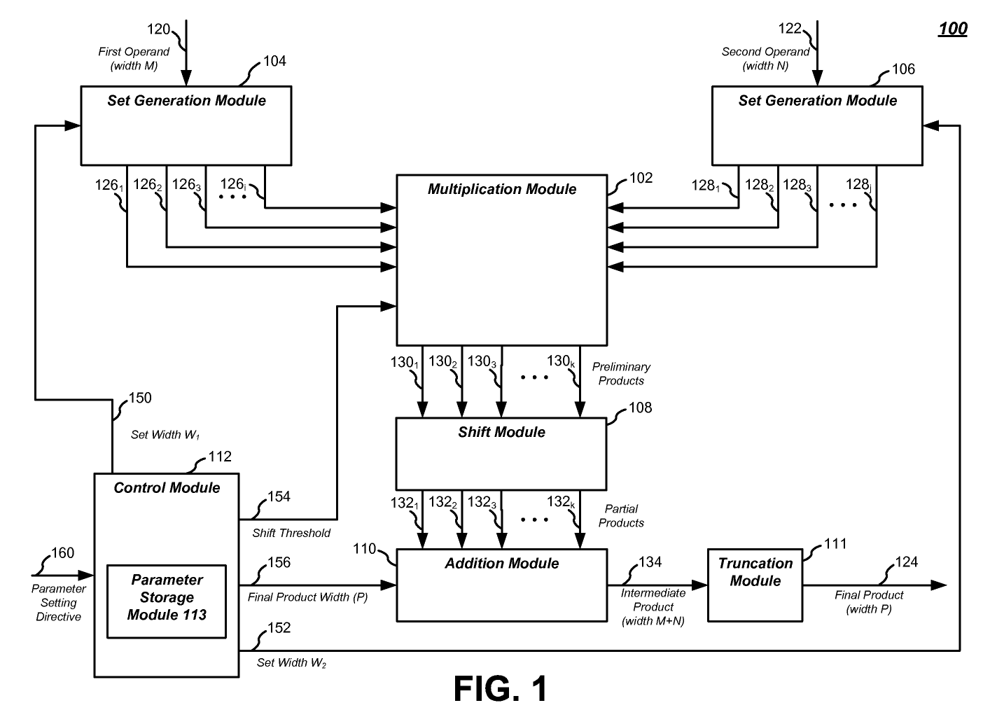

FIG. 1 is a diagram of an exemplary apparatus 100. This apparatus includes a multiplication module 102, set generation modules 104 and 106, a shift module 108, an addition module 110, a truncation module 111, and a control module 112. These elements may be implemented in any combination of hardware and/or software.

As shown in FIG. 1, apparatus 100 receives a first operand 120 having a bit width of M, and a second operand 122 having a bit width of N. M and N may be the same or different. In embodiments, first operand 120 may be a multiplier (e.g., a value received from a remote processing unit), and second operand 122 may be a multiplicand (e.g., a filter coefficient). Based on these inputs, apparatus 100 generates a final product 124. Final product 124 has a bit width P. In embodiments, P is less than M+N. Alternatively, P may be equal to or greater than M+N.

Set generation modules 104 and 106 separate the digits (e.g., binary digits) of operands 120 and 122 into multiple non-overlapping contiguous portions. These portions are also referred to herein as sets. As shown in FIG. 1, set generation module 104 breaks operand 120 into multiple sets 126₁-126ᵢ. Similarly, set generation module 106 breaks operand 122 into multiple sets 128₁-128ⱼ. In this case, i and j are integers (which may be equal or unequal).

Each of these sets may have a particular width of one or more digits. As shown in FIG. 1, the width of sets 126₁-126ᵢ is established by a set width parameter 150 (W₁), and the width of sets 128₁-128ⱼ is established by a set width parameter 152 (W₂). W₁ and W₂ may be the same or different.

Multiplication module 102 receives sets 126₁-126ᵢ and 128₁-128ⱼ. In turn, multiplication module 102 multiplies one or more set pairings. Each of these pairings includes one set from 126₁-126ᵢ and one set from 128₁-128ⱼ. For each set multiplication, multiplication module 102 generates a preliminary product. For instance, FIG. 1 shows multiplication module 102 generating preliminary products 130₁-130ₖ.

A shift (e.g., a shift of zero or more bits) corresponds to each set pairing. This shift is based on the positions of the pairing's sets within their respective operands 120 and 122. In embodiments, multiplication module 102 only multiplies pairings having shift values that are greater than or equal to a particular shift threshold parameter 154. Thus, multiplication module 102 bypasses the multiplication of pairings having corresponding shifts that are less than shift threshold parameter 154.

As shown in FIG. 1, shift module 108 receives preliminary products 130₁-130ₖ. In turn, shift module 108 performs the shift operations corresponding to these partial products. These shifts are performed within an M+N width. Additionally, for each shifting operation, shift module 108 may perform zero padding on the remaining portions of this width that do not include the shifted preliminary product. As a result, shift module 108 produces partial products 132₁-132ₖ, which have a width of M+N. FIG. 1 shows that these partial products are sent to addition module 110.

Addition module 110 sums partial products 132₁-132ₖ to produce intermediate product 134. Intermediate product 134 has a width of M+N. FIG. 1 shows that intermediate product 134 is sent to truncation module 111.

Truncation module 111 produces final product 124 from intermediate product 134. As described herein, final product 124 has a width of P, which may be less than the combined widths of operands 120 and 122 (i.e., less than M+N). Accordingly, in producing final product 124, truncation module 111 truncates intermediate product 134 to the P most significant digits (the P most significant bits). As shown in FIG. 1, truncation module 111 receives P as final product width parameter 156.

FIG. 1 shows that control module 112 generates parameters 150-156. These parameters may be stored in a parameter storage module 113. Parameter storage module 113 may be implemented with a storage medium, such as memory. In embodiments, parameters 150-156 are programmable. Accordingly, FIG. 1 shows control module 112 receiving a parameter setting directive 160, which establishes values for parameters 150-156. In embodiments, this directive may be received from remote entities. Through the programmable feature, parameters may be selected for various desired levels efficiency and/or accuracy. Moreover, apparatus 100 may be programmed to operate to consider the entire product width and behave like a regular multiplier (e.g., a regular multiplier with or without truncation).

A general example is now described in which two B bit numbers are multiplied. As described herein, this multiplication may be split into multiple smaller multiplication operations. In turn, the shifted products of these smaller operations are contributed (added) into a final multiplication product.

The multiplication of two B bit numbers typically produces a 2B bit product. However, in embodiments, a truncated version of this product is provided. More particularly, the C least significant bits are dropped from the product to produce a truncated product.

As described herein, embodiments may bypass certain multiplication and addition operations. Bypassing such operations may introduce an error in the untruncated product. Moreover, due to lost carries, this error may also be present in the truncated product.

To manage such errors, embodiments may bypass multiplications and additions that contribute towards the bits that are removed (truncated) from the final product. Additionally or alternatively, embodiments may bypass particular multiplications and additions such that the error introduced by their omission is within a particular margin of error.

As described herein, a shift threshold value may be employed to determine which multiplication operations are bypassed and which are performed. This shift threshold value may be selected in various ways. For instance, the shift threshold value may be selected based on a maximum error that may occur. More particularly, the shift threshold value may be selected such that the error in the final product (due to lost carries) is within a particular margin.

Compliance with this error margin may be determined by considering the multiplication of two maximum values. For instance, an example is provided in which two 32 bit numbers are multiplied. Typically, this multiplication produces a 64 bit final product. However, in this example, only the first 28 most significant bits (MSBs) are needed. In other words, the extra precision offered by the 36 least significant bits (LSBs) is not desired. Such truncations may be employed in graphics or display processing algorithms (such as in color space conversion algorithms).

To determine this maximum amount of error, the multiplication of two maximum values (i.e., 32 ones or FFFF_FFFF) is calculated to determine a maximum error limit (i.e., a maximum limit of error caused by lost carries).

In this example, each 32 bit operand is divided into 4 groups of 8 bits each. In particular, the first 32 bit multiplier of FFFF_FFFF is divided into 4 parts denoted by M1, M2, M3, and M4. Similarly, the second 32 bit multiplier of FFFF_FFFF is divided into 4 parts denoted by D1, D2, D3, and D4.

Multiplication operations are performed between each of these parts. For instance, D1 may be multiplied with M1 to produce a 16 bit result. Further, a corresponding bit shift operation and/or a zero padding operation may be performed on the result of each 8 bit×8 bit multiplication operation. From this multiplication (as well as any bit shifting/zero padding), each pairing of 8 bit parts produces a sub-product. Thus, the overall 16 bit×16 bit multiplication may be reduced to summing all the individual sub-products.

In this example, there are 16 combinations (or pairings) of parts. These combinations are listed below in Table 1.

TABLE 1

| Set 1 | | Set 2 | | Set 3 | | Set 4 | |
|---|---|---|---|---|---|---|---|
| M1*(D1) | 48 | M2*(D1) | 40 | M3*(D1) | 32 | M4*(D1) | 24 |
| M1*(D2) | 40 | M2*(D2) | 32 | M3*(D2) | 24 | M4*(D2) | 16 |
| M1*(D3) | 32 | M2*(D3) | 24 | M3*(D3) | 16 | M4*(D3) | 8 |
| M1*(D4) | 24 | M2*(D4) | 16 | M3*(D4) | 8 | M4*(D4) | 0 |

In Table 1, the combinations are arranged into four sets. For each pairing in Table 1, a number to the right indicates the effective shift to be performed for the pairing's product so that its corresponding sub-product is in the correct range. For example, the pairing of M1*(D1) has a corresponding 48 bit shift.

As described above, the multiplication of two B bit numbers typically produces a 2B bit product. For instance, multiplying FFFF_FFFF (i.e., all ones) with itself produces a 64 bit product of FFFF_FFFE_{—}0000_{—}0001. This value is the maximum possible product for two 32 bit numbers. However, as described above, only the 28 MSBs of this number are needed in this example. Thus, FFFF_FFFE_{—}0000_{—}0001 is truncated to FFFF_FFF.

Thus, embodiments may determine which multiplications should be employed to get a final product having a desirable level of accuracy. This may be programmable. For example, in FIG. 1, shift threshold parameter 154 determines which multiplication operations are bypassed by multiplication module 102.

For this example, a shift threshold parameter of 24 is employed. Thus, all sub products with a multiplication shift of 24 or greater are calculated. Table 2, below, provides information for each of the pairings that are retained. In particular, retained pairings are provided column 1, their corresponding shift value is provided in column 2, and their resulting sub-product is provided in column 3.

TABLE 2

| Pairing | Shift | Sub-Product (in decimal) |
|---|---|---|
| M1*(D1) | 48 | 18302910360610406400 |
| M1*(D2) | 40 | 71495743596134400 |
| M1*(D3) | 32 | 279280248422400 |
| M1*(D4) | 24 | 1090938470400 |
| M2*(D1) | 40 | 71495743596134400 |
| M2*(D2) | 32 | 279280248422400 |
| M2*(D3) | 24 | 1090938470400 |
| M3*(D1) | 32 | 279280248422400 |
| M3*(D2) | 24 | 1090938470400 |
| M4*(D1) | 24 | 1090938470400 |

Adding the sub-products of Table 2 yields the decimal value of 18446739688547942400. This value is FFFF_FFFB_{—}0400_{—}0000 in hexadecimal. Truncating this value to the 28 MSBs provides FFFF_FFF. This answer is mathematically equal to the truncated answer obtained by regular multiplication (which does not bypass the calculation of any sub-products).

Thus, the original 32 bit×32 bit multiplication was split into 16 smaller 8 bit×8 bit mini-multiplications. However, due to the final product being truncated to 28 bits, only 9 of the 16 possible mini-multiplications needed to be performed. This may advantageously save the employment of a significant amount of circuitry (e.g., gates) and power consumption.

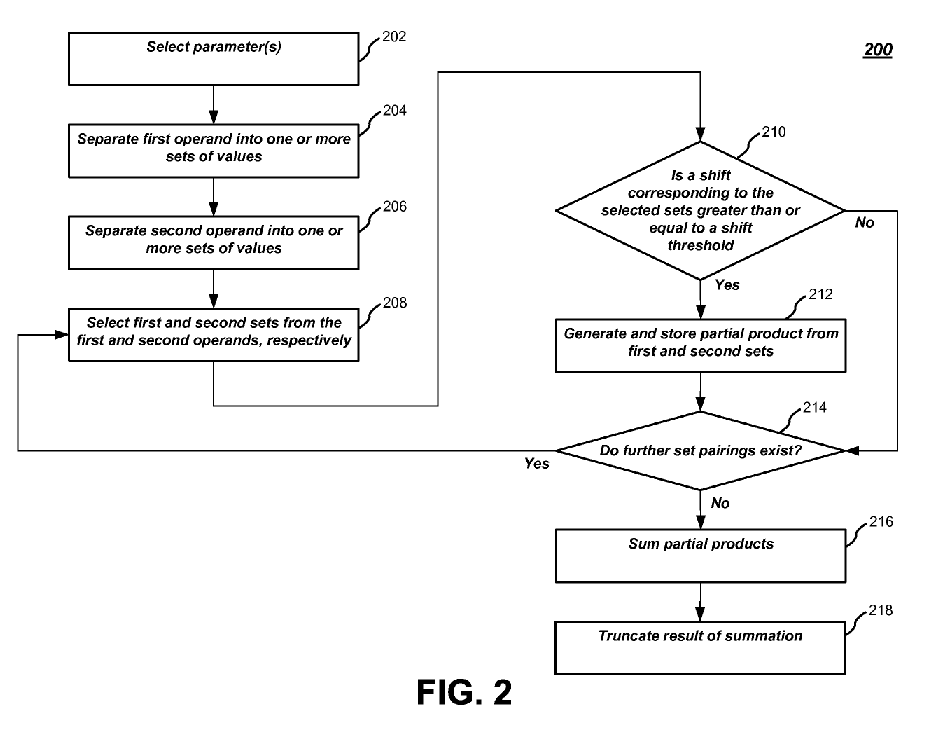

FIG. 2 illustrates an exemplary logic flow 200, which may be representative of operations executed by one or more embodiments described herein. Thus, this flow may be employed in the context of FIG. 1. Additionally or alternatively, these operations may be performed within a processing unit of a graphics or display processing pipeline. Embodiments, however, are not limited to such contexts. Also, although FIG. 2 shows particular sequences, other sequences may be employed. Moreover, the depicted operations may be performed in various parallel and/or sequential combinations.

At a block 202, one or more parameters are selected. These parameters may include (but are not limited to) one or more of a final product width, set width(s), and a shift threshold value. For example, in the context of FIG. 1, these parameters may include one or more of parameters 150-156.

At a block 204, a first operand is separated into multiple sets of values (multiple non-overlapping contiguous sets). Similarly, at a block 206, a second operand is separated into multiple sets of values (multiple non-overlapping contiguous sets). These separations may be in accordance with set width parameter(s) selected at block 202.

A pairing of sets is selected at a block 208. In particular, first and second sets are selected from the first and second operands, respectively. This selected set pairing is a candidate for the calculation of a mini-product. As described herein, a shift corresponds to this calculation. Thus, at a block 210, this corresponding shift is compared to a shift threshold. As described above, this shift threshold may have been selected at block 202.

FIG. 2 shows that if the corresponding shift is less than this threshold, then operation proceeds from block 210 to block 214. However, if the corresponding shift is greater than or equal to the threshold, then operation proceeds from block 210 to block 212.

At block 212, a partial product is generated and stored from the pairing selected at block 208. In embodiments, this partial product may be stored in its shifted form. Following block 212, operation proceeds to block 214.

At block 214, it is determined whether all possible first and second sets have been considered. If so, then operation proceeds to a block 216. Otherwise, operation returns to block 208, where a further pairing is selected. Thus, this flow may loop through all possible pairings of first and second sets.

As shown in FIG. 2, blocks 208 through 214 provide a loop in which pairings are handled sequentially. Embodiments, however, are not limited to this arrangement. For example, multiple pairings (e.g., all possible pairings) may be handled in parallel.

At block 216, the partial products generated and stored at block 212 are summed. Then, at a block 218, the result of this summation is truncated. This truncation may be in accordance with a final product width parameter that was selected at block 202.

This truncation yields a final product at a selected precision (width). This final product may be further processed. Alternatively, this final product may be communicated across an interconnection medium to a processing unit.

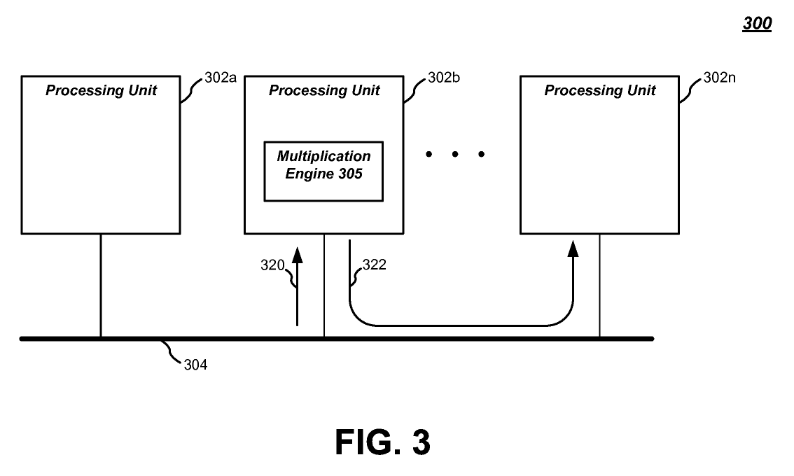

FIG. 3 is a diagram of an exemplary operational environment 300. This environment includes multiple processing units 302a-n and an interconnection medium 304. These elements may be implemented in any combination of hardware and/or software.

Each of processing units 302a-n may receive data and perform operations involving the received data. For example, FIG. 3 shows processing unit 302b receiving data 320 from interconnection medium 304. This data may be at a particular shared (or pipeline) precision.

Upon receipt, processing unit 302b may process data 320. In the context of graphics and display processing, this processing may involve the performance of a color space conversion algorithm. Embodiments, however, are not limited to this example. As shown in FIG. 3, this processing produces data 322, which is sent to processing unit 302n. Alternatively or additionally, this data may be passed to an output device, such as a display device. Like data 320, data 322 is also at the shared (or pipeline) precision.

The processing performed by processing unit 302b may involve one or more multiplications. As described herein, multiplications may generate data at higher precisions. In turn, this precision is reduced to comply with the shared precision.

However, in embodiments, the multiplication techniques described herein may be employed to produce results that are at the shared precision. For instance, FIG. 3 shows processing unit 302b including a multiplication engine 305 that performs such techniques. Accordingly, multiplication engine 305 may be implemented in the manner described above with reference to FIG. 1. Additionally or alternatively, multiplication engine 305 may perform the operations described above with reference to FIG. 2. As a result, multiplication results are efficiently produced at the shared precision.

In FIG. 3, interconnection medium 304 provides for couplings among elements, such as processing units 302a-n. For instance, interconnection medium 304 may include one or more point-to-point connections (e.g., parallel interfaces, serial interfaces, dedicated signal lines, etc.) between various pairings of processing units 302a-n.

Additionally or alternatively, interconnection medium 304 may include a multi-drop or bus interface that provides a physical connections processing units 302a-n. Exemplary bus interfaces include Universal Serial Bus (USB) interfaces, as well as various computer system bus interfaces.

Further, interconnection medium 304 may include one or more software interfaces (e.g., application programmer interfaces, remote procedural calls, shared memory, etc.) that provide for the exchange of data between software processes executed by one or more of processing units 302a-n.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Some embodiments may be implemented, for example, using a storage medium or article which is machine readable. The storage medium may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

As described herein, embodiments may include storage media or machine-readable articles. These may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While various embodiments of the present invention have been described above, it should be understood that they have been presented by way of example only, and not in limitation. For instance, the techniques described herein are not limited to using binary numbers. Thus, the techniques may be employed with numbers of any base.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method, comprising:
calculating a plurality of partial products from a first operand and second operand, wherein said calculating bypasses calculating partial products having corresponding shift values less than a shift threshold value;
summing the one or more partial products into a summed product
truncating the summed product into a final product having a final precision;

2. The method of claim 1, wherein said calculating the one or more partial products comprises:
a multiplication module receiving a plurality of first value sets and a plurality of second value sets; and
the multiplication module calculating a plurality of preliminary products from each pairing of a first value set and a second value set having a corresponding shift value that is greater than or equal to the shift threshold value.

3. The method of claim 2, further comprising producing the plurality of partial products from the plurality of preliminary products, wherein said producing comprises a shift module shifting each preliminary product by its corresponding shift value.

4. The method of claim 2, further comprising:
separating the first operand into the plurality of first value sets; and
separating the second operand into the plurality of second value sets.

5. The method of claim 4, wherein each of the plurality of first value sets comprises a contiguous set of digits from the first operand, and each of the plurality of second value sets comprises contiguous set of digits from the second operand.

6. The method of claim 1, wherein said truncating comprises truncating one or more least significant bits (LSBs) from the summed product.

6. The method of claim 1, wherein the final precision is a precision shared by multiple processing units.

7. The method of claim 6, further comprising sending the final product to one of the multiple processing units.

8. The method of claim 1, further comprising:
selecting the shift threshold value; and
directing the multiplication module to employ the shift threshold value.

9. The method of claim 1, further comprising selecting the final precision.

10. An apparatus, comprising:
a multiplication module to calculate a plurality of partial products from a first operand and second operand, wherein said calculating bypasses calculating partial products having corresponding shift values less than a shift threshold value;
an addition module to sum the one or more partial products into a summed product; and
a truncation module to truncate the summed product into a final product having a final precision.

11. The apparatus of claim 10, further comprising:
a first set generation module to produce a plurality of first value sets from the first operand; and
a second set generation module to produce a plurality of second value sets from the second operand;
wherein the multiplication module is to calculate a plurality of preliminary products from each pairing of a first value set and a second value set having a corresponding shift value that is greater than or equal to the shift threshold value.

12. The apparatus of claim 11, wherein each of the plurality of first value sets comprises a contiguous set of digits from the first operand, and each of the plurality of second value sets comprises contiguous set of digits from the second operand.

13. The apparatus of claim 12, wherein each of the plurality of first values sets has a same width.

14. The apparatus of claim 12, wherein each of the plurality of second value sets has a same width.

15. The apparatus of claim 10, further comprising a control module to direct the multiplication module to employ the shift threshold value.

16. The apparatus of claim 10, wherein the control module establishes the shift threshold value as a programmable setting.

17. The apparatus of claim 10, wherein the control module establishes the final precision as a programmable setting.

18. A system comprising:
a plurality of processing units; and
a interconnection medium to exchange data between the plurality of processing units, the data having a shared precision;
wherein at least one of the processing units includes a multiplication engine, the multiplication engine comprising:
a multiplication module to calculate a plurality of partial products from a first operand and second operand, wherein said calculating bypasses calculating partial products having corresponding shift values less than a shift threshold value, an addition module to sum the one or more partial products into a summed product, and
a truncation module to truncate the summed product into a final product having a shared precision.

19. The system of claim 18, wherein at least one of the first operand and the second operand is received from the interconnection medium.

20. The system of claim 18 wherein the multiplication engine is associated with a color space conversion algorithm.
